(19) United States
(12) Patent Application Publication
(10) Pub. No.: US 2007/0096892 A1
(43) Pub. Date: May 3, 2007

(54) METHOD AND SYSTEM OF ALERTING HAZARDS

(75) Inventors: John F. Nathan, White Lake, MI (US); H. Winston Maue, Northville, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/163,789

(22) Filed: Oct. 31, 2005

(51) Int. Cl. B60Q 1/52; G08B 1/00; G08G 1/00

(52) U.S. Cl. 340/471; 340/531; 340/901

(57) ABSTRACT

A method and system for alerting a hazard. The method and system including generating a warning signal for alerting the hazard and communicating the warning signal to oncoming vehicles through vehicle to vehicle communications.

### BACKGROUND OF THE INVENTION

1. Technical Field

The present invention relates to the methods and systems of alerting hazards.

2. Background

Automotive vehicles and other traveling vehicles may encounter various hazards during operation. The hazards may range from vehicular accidents, road construction, dangerous road conditions (weather, curves, gradient, etc.), and any number of other perils. In highway or other high-speed environments, vehicle operators may be rapidly approaching the hazard such that multiple vehicle collisions and pile-ups can occur if the oncoming vehicles are unaware of the impending hazard or otherwise insufficiently alerted to the existence thereof.

### SUMMARY OF THE INVENTION

One non-limiting aspect of the present invention relates to alerting hazards, such as to permit vehicle operators to become aware of the hazard in a manner sufficient to ameliorate the likelihood of multiple vehicle collisions and pile-ups.

One non-limiting aspect of the present invention relates to a method of alerting a hazard. The method may include generating a warning signal for alerting the hazard and communicating the warning signal to oncoming vehicles through vehicle to vehicle communications.

The method may include executing an alerting feature included on one or more of the vehicles receiving the warning signal.

The method may include the alerting feature being a patterned flasher that flashes a particular pattern depending on a type of hazard identified by the warning signal and/or an audio or visual indicator that provides a particular audio or visual indicator depending on a type of hazard identified by the warning signal.

The method may include only executing the alerting feature if the vehicle is approaching the hazard with a desired directionality.

The method may include only executing the alerting feature if the vehicle is within a hazardous distance zone defined relative to the hazard.

The method may include defining the hazardous distance zone as a function of at least one of distance to the hazard, vehicle speed, hazard incident type, and directionality relative to the hazard.

The method may include receiving instructions for manually overriding the alerting feature from a vehicle occupant.

The method may include resetting the manual override if the overridden vehicle is warned of a new hazard.

The method may include generating the warning signal in response to activation of a vehicle crash sensor.

The method may include generating the warning signal in response to activation of a road-side warning feature.

The method may include generating the warning so as to track information associated with the vehicles included within the vehicle to vehicle communications.

The method may include generating the warning signal in response to activation of an emergency alert signal by an emergency response entity.

The method may include including an incident identifier with the warning signal, the incident identifier including information regarding the hazard.

The method may include controlling operation of an alerting feature included on one or more vehicles as a function of the incident identifier.

The method may include communicating the warning signal from at least one of the vehicles to a non-vehicle feature such that the non-vehicle feature executes an alerting operation in response thereto.

The method may include limiting the vehicle to vehicle communications as a function of vehicle directionality.

The method may include limiting the vehicle to vehicle communications includes preventing communications of the warning signal from vehicles traveling in a non-hazardous direction relative to the hazard.

The method may include limiting the vehicle to vehicle communications as a function of vehicle range.

The method may include limiting the vehicle to vehicle communications as a function of vehicle to vehicle distance/speed.

One non-limiting aspect of the present invention relates to a system of alerting a hazard. The system may include a warning signal associated with the hazard and a number of vehicles having communication elements for relaying the warning signal from vehicle to vehicle so as to alert the vehicles to the hazard.

The system may include an alerting feature for generating an alert in response to the warning signal, such as on-board the vehicles and/or associated with a non-vehicle entity.

The warning signal may include a directionality feature so as to limit alerts to a hazardous direction associated with the hazard.

The warning signal may include a distance feature so as to limit alerts to a hazardous distance zone associated with the hazard.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawing in which:

FIGURE 1 illustrates a hazard alerting system in accordance with one non-limiting aspect of the present invention.

### DETAILED DESCRIPTION OF THE PREFERRED EMBODIMENT(S)

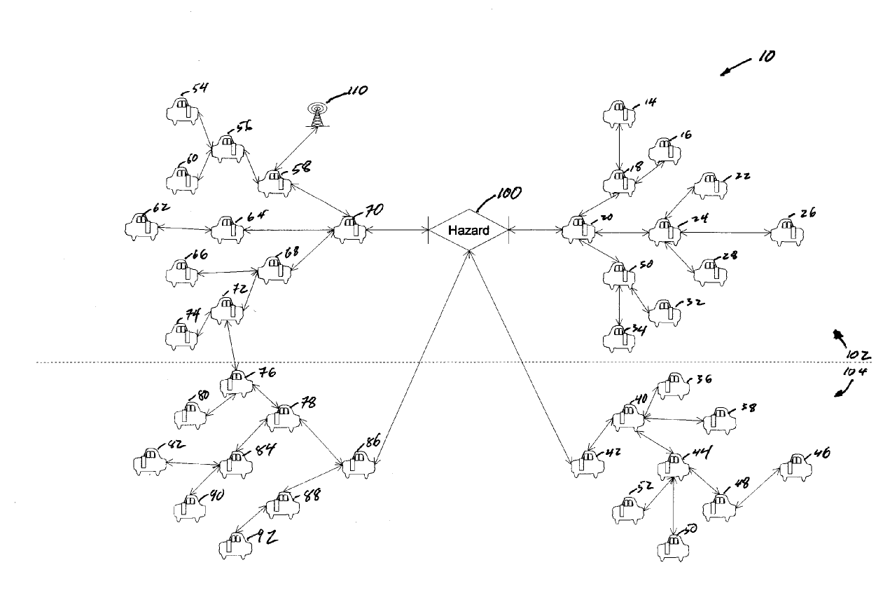

FIGURE 1 illustrates a hazard alerting system 10 in accordance with one non-limiting aspect of the present invention. The system 10 is illustrated, for exemplary purposes, with respect to an automotive environment having multiple vehicles 14-92 traveling relative to a hazard 100. This example is provided for exemplary purposes and is not intended to limit the scope of the present invention. Rather, the present invention fully contemplates its application in any number of vehicular environments where hazards may occur.

The vehicles 14-92 shown in FIGURE 1 are automobiles traveling on highways and/or roadways. An upper portion 102 of the vehicles 14-92 may be considered to be traveling in an up-bound direction and a lower portion 104 of the vehicles 14-92 may be considered to be traveling in a down-bound direction, however, the vehicles 14-92 could be similarly approaching an intersection or otherwise crossing paths. The vehicles 14-92 are shown as automobiles but they may similarly be trains, planes, watercraft, and any number of other moving vehicles.

The two-way traffic shown in FIGURE 1 is provide for exemplary purposes and without intending to limit the scope of the present invention. The present invention fully contemplates the traffic traveling in any number of directions relative to the hazard 100, such as with respect to airplane or watercraft travel patterns that may not follow pathways defined by roads or other track-ways.

One or more of the vehicles 14-92 may include a communication element (shown with boxes) for facilitating communications with other electronically communicable features associated with the system 10. The communication elements may be configured to communicate according to any number of standards and protocols and through any number of communications mediums, such as short/long range, land/satellite based wireless communications.

The communication elements may be configured to communicate wireless signals between other vehicles 14-92 in proximity thereto, such as through signal relaying and the like. Depending on the communication standard and protocols used, these communications may be used to establish networks, daisy-chains, and other mediums for exchanging signals between the vehicles 14-92. For example, mesh, clusters, and star networks may be created between the vehicles 14-92 and controlled by one or more lead vehicles, such as according to Zigbee or IEEE standards (e.g. 802.15.4).

This vehicle to vehicle communication may be used to alert other vehicles 14-92 of the hazard 100 or other incident. For example, if the hazard 100 is associated with a traffic accident, one or more of the vehicles 14-92 involved in the accident may generate a warning signal to the other oncoming vehicles 14-92 to alert them of the hazard 100. The warning signals may be relayed from vehicle to another through one or more of the networks or other communication mediums associate therewith.

The warning signal may be generated to inform the other vehicles 14-92 of the accident, such as in response to a activation of a crash sensor on one of the vehicles 14-92 and/or through some other feature, such as from a rapid deceleration or stopping operation occurring with respect to one or more of the vehicles 14-92, which may be tracked through on-vehicle devices and/or other features, such as, but not limited to Global position systems (GPS), speed sensing, and distance determinations. The warning signal may then be transmitted to the other vehicles 14-92 through some form of vehicle to vehicle communication.

Each vehicle 14-92 in proximity to the hazard (accident) may receive the warning signal and relay it to the other vehicles 14-92 through vehicle to vehicle communications such that each vehicle 14-92 is responsible for determining whether it is to activate an alerting feature in response thereto and/or to relay the signal further.

The alerting feature may be associated with a patterned flasher (head/rear lights, interior lights, over-head lights, etc.) on the interior and/or exterior of the vehicles 14-92 that begins to flash in response to receipt of the warning signal. The flashing pattern, frequency, etc. may be determined as function of incident information carried within the warning signal. Likewise, the alerting feature may be associated with audio and/or visual indicators on or in association with the vehicles, which also may be varied depending on the incident information.

Optionally, the vehicles 14-92 may include a manual override feature to facilitate deactivating an active alert feature, such as to turn off the flashers and/or the audible alert. This may be helpful when continued alerts are unnecessary, such as if traffic is moving slowly towards the hazard e.g. traffic jam, rendering continued alerts unnecessary. The warning signal may include information defining such conditions so as to permit automatic overriding, such as by specifying maintenance of a minimum vehicle speed, distance relative to other vehicles, or other parameters. The communications element may include an additional reset feature to override a manual deactivation, such as in response to the occurrence of another hazard or change in status of the known hazard.

The warning signal may include a directionality feature for use by the communication element in determining whether the vehicles 14-92 are approaching the hazard from a hazardous or non-hazardous direction. As shown in FIGURE 1, the hazard 100 has occurred in the up-bound direction such that vehicles 14-92 in the down-bound direction do not necessarily need to activate the alerting feature in response to the accident, although they could. The relevant, or hazardous, direction may be determined as a function of the warning signal. For example, the communication element for the vehicle(s) 14-92 involved in the accident may include a magnetic compass/chip for tracking its path of travel. This information, along with driving speed and/or other operating parameters, may be used by the communication feature to determine a direction of travel prior to the accident.

Such pre-incident, and in some cases post-incident information, may be included with the warning signal to warn other vehicles 14-92 traveling with a similar directionality of the impending hazard. GPS, directional antennae, and other features may be similarly be used. This directionality may then be used by the receiving vehicle communication elements for determining if they are approaching the hazard from a hazardous direction (alert on) and/or if they have passed or are approaching the hazard from a non-hazardous direction (alert off).

The warning signal may also include a timing feature or beacon to indicate distance relative to the hazard 100. This may be helpful in alerting the oncoming vehicles 14-92 of a distance to the hazard 100 and for tracking whether the vehicles 14-92 have passed the hazard 100, in which case the alert feature may be automatically deactivated by the associated communication feature. In this manner, the communication elements may need to only receive a single communication from the hazard 100 in order to monitor the alert and control its deactivation. Similarly, however, the communication feature may be configured to periodically poll or otherwise require continuous exposure to the warning signal in order to maintain the corresponding alert.

The communication elements may also be configured to limit how far the warning signal is relayed from the hazard 100 through the vehicle to vehicle communications. For example, based on directionality, the communications element may be instructed to cease further relaying of the warning signal in the non-hazardous directions. Likewise, the communication elements may limit relaying of the warning signals as a function of distance from the hazard and/or whether that distance corresponds with a hazardous distance zone.

For example, the hazardous distance zone may be defined as a function of the incident information, the rate at which the vehicles are traveling, or some other parameter(s). If the vehicles 14-92 are traveling at a relevant fast rate of speed and/or if the incident is extreme and/or biologically hazardous, it may be necessary to permit the warning signal to travel greater distances from the hazard 100, i.e., between more vehicles, so as to warning vehicles 14-92 located at longer distance from the hazard 100.

Optionally, the hazardous zone may include a hazardous directionality component such that the communication elements only further transmit the warning signal if the vehicle 14-92 is traveling within the hazardous distance zone and in the direction of the hazard. As such, the spread of the warning signal may be controlled by managing the relaying of the warning signals and/or as a function of how the warning signal is used by the receiving vehicles 14-92 to generate alerts, i.e., permitting relay of the warning signal but prohibiting action in response thereto.

The alerting features described above relate to on-vehicle elements that may be used to warn the driver (sound, visual) and/or other drivers (flashers) of the hazard. Likewise, the warning signal may travel to emergency response entities from one or more of the vehicles, such as to police, fire, medical, and other emergency responding entities. For example, a road-side relay feature 110, such as signage, radio towers, and other fixed and non-fixed markers/relays may include communication elements to intercept the vehicle to vehicle communications and to alert the emergency entities in response thereto.

Any number of the road-side relay features 110 may be used to communicate with any number of non-vehicle entities, such as the above-described emergency response entities. In addition, warning signals communicated from the relay and/or directly from the vehicles may be used for executing other alerts, such as for displaying electronic messages on electronic billboards, adjusting traffic light signaling, adjusting street light operations (flashing), and the like.

The relaying of the warning signal in this manner allows the present invention to relay between multiple vehicles 14-92 for receipt by non-vehicle entities located near or far from the hazard 100 or warning signal source so that the non-vehicle entities may execute any number of alerting features. This may also be advantageous in tracking and locating specific vehicles including with the daisy-chain. For example, each signal relayed from the communication elements may include an identifier, such as a vehicle identification number (VIN), that may be used to locate and track the vehicle. This information may then be transmitted to emergency response entities and used for homeland security.

Another application of relaying the warning signal from vehicle to vehicle relates to associating the road-side feature with functioning elements, such as to facilitate changing traffic lights (non-vehicle alerts) and warning drivers (in-vehicle alerts) of oncoming emergency vehicles, such as a police cars, ambulance, and the like. Similar to the foregoing accident description, the warning signal may be communicated from the emergency response vehicle, i.e., the emergency response vehicle becomes the hazard 100.

The warning signal can travel from vehicle to vehicle in a direction in which the emergency vehicle is traveling but at a much greater rate of speed, thereby identifying the emergency vehicle's direction travel as the hazard, which can be used to alert both up-bound and down-bound traffic to the emergency vehicle (multi-direction hazard and dynamic hazard distance zone). The warning signal may include incident identifiers having instructions to change the status of stop lights and/or to display emergency messaging on electronically controllable signage, such as to indicate a nature of the hazard and/or the need to move to a side of the road to permit passage of the emergency vehicle.

This vehicle to vehicle communication may be used in conjunction with other hazards, such as the presence dangerous road conditions (weather, curves, gradients, etc.), road construction, traffic delays, and the like so that warning signals associated therewith may be communicated to the oncoming vehicles. In this manner, the hazard may be associated with one of the vehicles 14-92 or some other source and generated from non-vehicle features, such as a road-side sign 110.

For example, street signs 110 indicating dangerous road conditions, construction, etc. may communicate the warning signal from a semi-fixed location to oncoming vehicles such that the warning signals are thereafter relayed to additional vehicles through vehicle to vehicle communications. The relaying of these warning signals and the alerts instigated in response thereto may be controlled in manner similar to that described above, i.e., based on distance, directionality, type of incident, etc.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

1. A method of alerting a hazard, the method comprising:
generating a warning signal for alerting the hazard; and
communicating the warning signal to oncoming vehicles through vehicle to vehicle communications.

2. The method of claim 1 further comprising executing an alerting feature included on one or more of the vehicles receiving the warning signal.

3. The method of claim 2 wherein the alerting feature is a patterned flasher that flashes a particular pattern depending on a type of hazard identified by the warning signal.

4. The method of claim 2 wherein the alerting feature is an audio or visual indicator that provides a particular audio or visual indicator depending on a type of hazard identified by the warning signal.

5. The method of claim 2 further comprising only executing the alerting feature if the vehicle is approaching the hazard with a desired directionality.

6. The method of claim 2 further comprising only executing the alerting feature if the vehicle is within a hazardous distance zone defined relative to the hazard.

7. The method of claim 6 further comprising defining the hazardous distance zone as a function of at least one of distance to the hazard, vehicle speed, hazard incident type, and directionality relative to the hazard.

8. The method of claim 2 further comprising receiving instructions for manually overriding the alerting feature from a vehicle occupant.

9. The method of claim 8 further comprising resetting the manual override if the overridden vehicle is warned of a new hazard.

10. The method of claim 1 further comprising generating the warning signal in response to activation of a vehicle crash sensor.

11. The method of claim 1 further comprising generating the warning signal in response to activation of a road-side warning feature.

12. The method of claim 1 further comprising generating the warning so as to track information associated with the vehicles included within the vehicle to vehicle communications.

13. The method of claim 1 further comprising generating the warning signal in response to activation of an emergency alert signal by an emergency response entity.

14. The method of claim 1 further comprising including an incident identifier with the warning signal, the incident identifier including information regarding the hazard.

15. The method of claim 14 further comprising controlling operation of an alerting feature included on one or more vehicles as a function of the incident identifier.

16. The method of claim 1 further comprising communicating the warning signal from at least one of the vehicles to a non-vehicle feature such that the non-vehicle feature executes an alerting operation in response thereto.

17. The method of claim 1 further comprising limiting the vehicle to vehicle communications as a function of vehicle directionality.

18. The method of claim 17 wherein limiting the vehicle to vehicle communications includes preventing communications of the warning signal from vehicles traveling in a non-hazardous direction relative to the hazard.

19. The method of claim 1 further comprising limiting the vehicle to vehicle communications as a function of vehicle range.

20. The method of claim 1 further comprising limiting the vehicle to vehicle communications as a function of vehicle to vehicle distance/speed.

21. A communication element on-board a vehicle, the element configured to:
receive a warning signal associated with a hazard; and
relay the warning signal to an additional vehicle so as to alert the additional vehicle of the hazard.

22. The element of claim 21 further configured to facilitate activating an alerting feature in response to the warning signal.

23. The element of claim 22 further configured to facilitate activating the alerting feature on-board the vehicle.

24. The element of claim 22 further configured to facilitate activating the alerting feature of a non-vehicle entity.

25. The element of claim 21 further configured to interrogate the warning signal for a directionality feature, to determine a hazardous direction associated with the hazard as a function of the directionality feature, and to limit further communication of the warning signal to the hazardous direction associated with the hazard.

26. The element of claim 21 further configured to interrogate the warning signal for a distance feature, to determine a hazardous distance zone associated with the hazard as a function of the distance feature, and to limit further communication of the warning signal to the hazardous distance zone.
